(19) United States
(12) Patent Application Publication
(10) Pub. No.: US 2009/0251597 A1
(43) Pub. Date: Oct. 8, 2009

(54) CONTENT CONVERSION DEVICE

(75) Inventors: Genta SUZUKI, Kawasaki (JP); Hirotaka Chiba, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/409,705

(22) Filed: Mar. 24, 2009

(30) Foreign Application Priority Data
Mar. 25, 2008 (JP) 2008-076903

(51) Int. Cl. H04N 7/01

(52) U.S. Cl. 348/441; 348/E07.003

(57) ABSTRACT

A content conversion device includes a non-still picture data detecting unit which detects non-still picture data contained in a first electronic document that is an object to be processed, an embedded image generating unit which generates, in a data addition target image representing a frame contained in the non-still picture data or an image associated with the non-still picture data, embedded image data in which information about the non-still picture data is embedded, and an electronic document converting unit which creates a second electronic document in which the non-still picture data of the first electronic document is replaced with the embedded image data.

### CROSS-REFERENCE TO RELATED APPLICATIONS

This application is based upon and claims the benefit of priority of the prior Japanese Patent Application No. 2008-076903, filed on Mar. 25, 2008, the entire contents of which are incorporated herein by reference.

### FIELD

The embodiments discussed herein are related to a content conversion device which converts an electronic document containing data such as a moving picture and a sound to electronic data that can be used in a printing device, an electronic paper, and the like.

### BACKGROUND

Electronic documents such as an HTML (Hyper Text Markup Language) which are acquired and viewed on a computer by a user have become widespread due to the spread of the Internet and the increasing speed of computers. Compared to paper documents, these electronic documents have an advantage that non-still picture data such as a sound or an image may be inserted therein and can be viewed on a display of a computer, a PDA (Personal Digital Assistant), a portable telephone, and the like.

When an electronic document is used, the document may not only be displayed on a display, but also may be printed as a paper document or outputted to a device such as an electronic paper which can display a still image with reduced power consumption. However, neither a paper document nor an electronic paper can output non-still picture data. Therefore, when an electronic document containing non-still picture data is printed or outputted to an electronic paper, information of the non-still picture data part is lost.

As a related art to a printing system which prints an electronic document containing moving picture data, a printing system has been disclosed in which the existence, content, and the like of non-still picture data may be known from a printout result, and any scene or state of the non-still picture data may be printed out. In this system, an electronic document in which moving picture data or sound data is converted to a mark or a character is outputted as a printed document.

In addition, as for a method for accessing moving picture data and the like, a view method has been described which improves visibility using smaller data to view image (moving picture, still picture) data. Further, a thumbnail display device and a thumbnail display program has been disclosed in which a user can view an outline of desired moving picture data in a short time.

### SUMMARY

According to an aspect of an embodiment, a content conversion device includes a non-still picture data detecting unit which detects non-still picture data contained in a first electronic document that is an object to be processed, an embedded image generating unit which generates, in a data addition target image representing a frame contained in the non-still picture data or an image associated with the non-still picture data, embedded image data that is a data addition target image in which information about the non-still picture data is embedded, and an electronic document converting unit which creates a second electronic document in which the non-still picture data of the first electronic document is replaced with the embedded image data.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram for illustrating a configuration of a content conversion device of an embodiment;

FIG. 2 is a diagram for illustrating content conversion of an electronic document containing non-still picture data;

FIG. 3 is a flowchart of an operation of the content conversion device of the embodiment;

FIG. 4 is a diagram for explaining a method for embedding information in a data addition target image;

FIG. 5 is a flowchart of an operation performed when information is embedded in a data addition target image;

FIG. 6 is a diagram for explaining an example of a hardware configuration for performing content conversion;

FIG. 7 is a flowchart of an operation of a content conversion device of another embodiment;

FIG. 8 is a diagram for explaining display of non-still picture data from an embedded image data;

FIG. 9 is a flowchart of an operation performed by an image processing device when non-still picture data is displayed using embedded image data;

FIG. 10 is a flowchart of an operation performed by the image processing device when information about non-still picture data is acquired using embedded image data; and

FIG. 11 is a diagram for explaining an example of hardware configuration for reproducing non-still picture data.

### DESCRIPTION OF EMBODIMENTS

As a method to which the system of the above described technique is applied for containing link information in a print document, it is conceivable that link information to non-still picture data is inserted as text information of a URL (Uniform Resource Locator) and printed. In this case, for accessing non-still picture data, a user inputs a URL shown on a printed document into a device such as a computer which can display non-still picture data and the like, and accesses the non-still picture data on the device. However, it is troublesome for a user to input a URL in a print document into a computer using a keyboard or the like, and an input error or the like may occur.

To solve the problems, a content conversion device is provided to generate an electronic document that can be outputted to a device that does not support non-still picture data from an electronic document containing non-still picture data without losing information.

Hereinafter, embodiments will be described in detail with reference to the drawings.

<Outline>

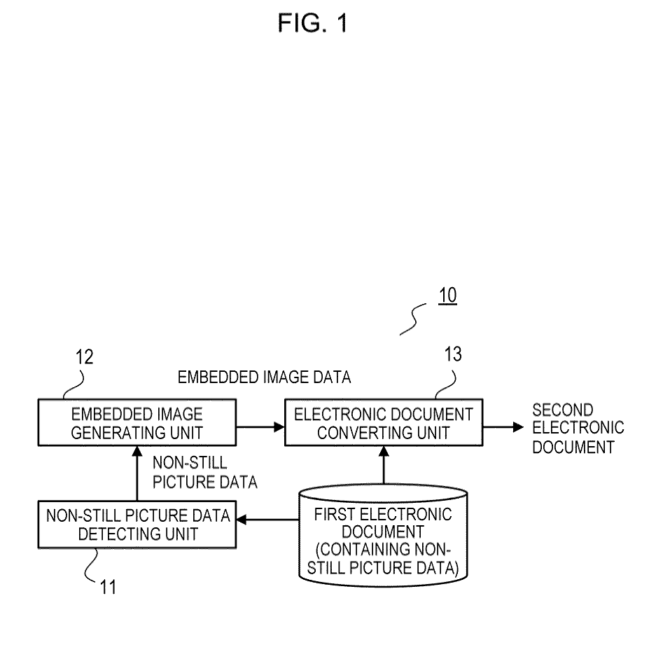

FIG. 1 is a diagram for illustrating a configuration of a content conversion device 10 of an embodiment. The content conversion device 10 includes non-still picture data detecting unit 11 which detects non-still picture data contained in an electronic document that is an object to be processed (hereinafter referred to as “first electronic document”), an embedded image generating unit 12 which generates image data to be embedded in the first electronic document (hereinafter referred to as “embedded image data”) in place of the detected non-still picture data, and an electronic document converting unit 13 which generates an electronic document in which the embedded image data of the first document is embedded (hereinafter referred to as “second electronic document”).

The first electronic document as used herein may be, for example, electronic data such as HTML, XML (Extensible Markup Language), or SGML (Standard Generalized Markup Language), in which non-still picture data such as moving picture data or sound data is contained.

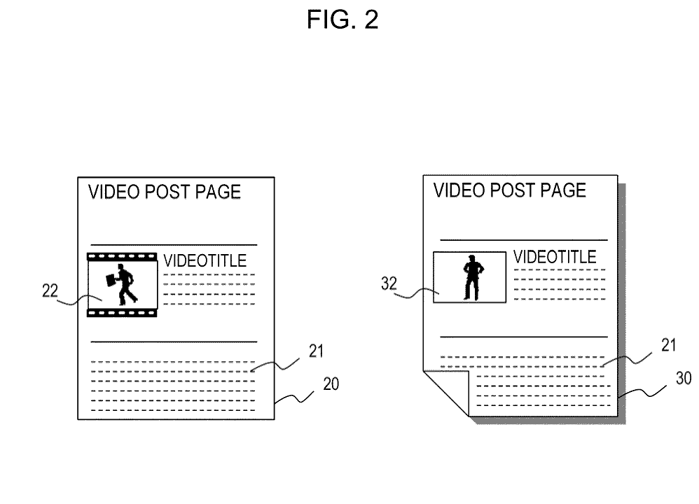

Electronic data 20 illustrated in FIG. 2 is an example of the first electronic document. The electronic data 20 illustrated in FIG. 2 is an HTML format electronic document in which text data 21 and moving picture data 22 are contained.

The second electronic document may be, for example, electronic data such as HTML, XML, or SGML in which non-still picture data is not contained.

Electronic data 30 illustrated in FIG. 2 is an example of the second electronic document. The electronic data 30 illustrated in FIG. 2 is an HTML format electronic document in which text data 21 and embedded image data 32 which is image data of a non-still picture, are contained.

The first and second electronic documents are not limited to the above described formats such as HTML and XML, and may be any electronic data in which non-still picture data or still picture data is contained.

(1) The non-still picture data detecting unit 11 checks whether or not non-still picture data is contained in the electronic document 20 that is an object to be processed. Non-still picture data as used herein refers to electronic data other than text data and a still image. Examples of non-still picture data include moving picture data and music data.

(2) The embedded image generating unit 12 acquires information about the non-still picture data detected by the non-still picture data detecting unit 11. In addition, the embedded image generating unit 12 generates still picture data to be embedded in the first electronic document in place of the non-still picture data. Then, the embedded image generating unit 12 embeds the information about the non-still picture data in the still picture data, thereby generating embedded image data.

“Information about non-still picture data” as used herein may be, for example, information (e.g., link information such as a URL) about a location where the non-still picture data is stored (e.g., a location on the content conversion device 10 or an information processor or the like connected with a network, in which the non-still picture data is stored), information about announcements and advertisements about the non-still picture data, and/or information about how to obtain the non-still picture data. The still picture data used here by the embedded image generating unit 12 to embed the information about the non-still picture data, may be data having a strong association with the non-still picture data, for example, one frame of the moving picture data. As used herein, a still image in which link information is to be embedded shall be referred to as “data addition target image”.

(3) The electronic document converting unit 13 replaces the non-still picture data contained in the first electronic document with the embedded image data created by the embedded image generating unit 12. By this replacement, the second electronic document containing the embedded image data in place of the non-still picture data is generated. The second electronic document does not contain the non-still picture data, but retains information about the non-still picture data as, for example, link information to the non-still picture data.

(4) The second electronic document generated as described above can be outputted to an electronic paper, a display, a printer or the like, or printed on a paper or the like. Then, the user captures, with an image processing device, a displayed or printed version of the second electronic document, and extracts the information about the non-still picture data. Thereby, the user can access the non-still picture data from the second electronic document.

The image processing device used for capturing the second electronic document is a device having a function of analyzing embedded image data and a function of connecting to a network. The image processing device analyzes the embedded image data part in the captured second electronic document to acquire, for example, link information. The user can access the original electronic document or the non-still picture data contained in the original document using the link information acquired by the image processing device. Therefore, when this content conversion method is used, there is no need to manually input information about non-still picture data, e.g., link information such as URL. In this way, access to the non-still picture data is made easier, and trouble due to an input error can be reduced if not prevented.

Generally, when the first electronic document containing non-still picture data is printed, the appearance of the printed document may be degraded compared to the electronic document 20 since the non-still picture data cannot be printed in a position where the non-still picture data is laid out. However, if the second electronic document created by the content conversion device 10 is printed or the like, embedded image data is printed in the layout position of the non-still picture data, and therefore such degradation of appearance can be reduced if not prevented.

Further, when a still image having a strong association with the non-still picture data is chosen as a data addition target image for the creation of embedded image data, there is an advantage that a user can easily estimate a content of the non-still picture data from the embedded image data.

Creation of the second electronic document is performed not only when the first electronic document is printed, but also when the first electronic document is outputted to a display device such as an electronic paper, which cannot display non-still picture data, or to a display device prohibited from displaying non-still picture data.

### Embodiments

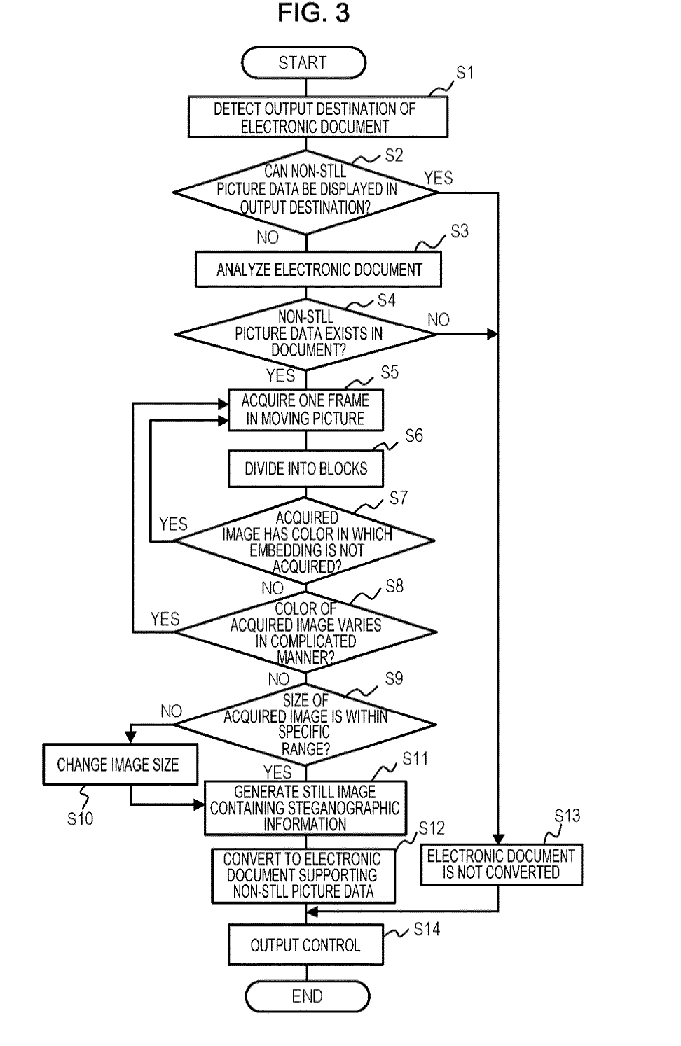

Hereinafter, a method for creating the second electronic document, and operation of each part of the device during the creation will be described in detail. FIG. 3 is a flowchart of an operation of the content conversion device 10 of the embodiment. Here, non-still picture data is moving picture data here, but is not limited as such.

{Determination of the Necessity of Creation of the First Electronic Document}

When receiving an instruction from a user to output the first electronic document, for example, the content conversion device 10 detects an output destination of the first electronic document, and checks whether or not the output destination device is a device that can support non-still picture data (steps S1, S2).

A device that does not support non-still picture data herein refers to, for example, a display device which cannot display electronic data containing non-still picture data, a display device prohibited from displaying it, or a device which cannot print.

The content conversion device 10 may be configured to have, for example, a definition file in which a node (device) that can display non-still picture data is defined, and to determine whether or not an output destination can support non-still picture data based on the definition file.

If the output destination is a node which cannot display non-still picture data, the non-still picture data detecting unit 11 checks whether or not non-still picture data is contained in the second electronic document (steps S3, S4).

For example, if the first electronic document is HTML format data, the non-still picture data detecting unit 11 searches the source file of the document to retrieve non-still picture data using an extension of a linked file. If non-still picture data is contained in the first electronic document, the content conversion device 10 determines that it is necessary to create a second electronic document.

On the other hand, if non-still picture data is not contained in the first electronic document, since there is no problem even if the first electronic document is printed as is, the first electronic document is outputted without being processed (step S13). Also, if the output destination node is a node which can display non-still picture data, the content conversion device 10 outputs the first electronic document (step S13).

{Generation of Embedded Image Data}

When the content conversion device 10 determines that it is preferable to generate a second electronic document which does not contain non-still picture data, the content conversion device 10 acquires still picture data that is to be a target in which information about non-still picture data is to be embedded (steps S5 to S8). In the following description, an example where link information is embedded as information about non-still picture data will be described.

As the still picture data that is a target in which link information is to be embedded, still picture data having a strong association with the non-still picture data is used. It is assumed here that any frame in the moving picture data, which is included in the non-still picture data, may be selected (step S5).

Upon acquiring the still picture data, the content conversion device 10 checks whether or not the still picture data is an image suitable to have steganographic information embedded therein (steps S6 to S8). In this configuration, the content conversion device 10 is provided with two parts, a difference value acquisition possibility determining unit and a feature quantity variation determining unit, and these parts determine whether or not the acquired still image is suitable to have steganographic information embedded therein. Alternatively, the embedded image generating unit 12 may be configured to determine whether or not the image is suitable.

In the embodiment, by steganography, an image is divided into a plurality of blocks, and a feature quantity is varied for each block pair composed of two adjacent blocks such that data is embedded. To acquire the embedded data, the image containing steganographic information is divided into a plurality of blocks, and a feature quantity for each block is acquired, and each block pair is analyzed.

Therefore, an image from which a variation of a feature quantity is difficult to be read after link information is embedded is unsuitable for a data addition target image. In the following example, each component of the RGB color system is represented by 256 gray-value levels. The darkest value of the 256 gray-value levels is 0 and the brightest value is 255. For example, when a B component of the RGB color system is an object to be adjusted as a feature quantity, an image whose color tone is dark and nearly black where each gray-value of the RGB components is less than 50 is determined to be unsuitable as a data addition target image because it is difficult to recognize the variation of feature quantities in the image.

In addition, an image where color components are greatly varied is also determined to be unsuitable as a data addition target image.

Whether or not an image is suitable as a data addition target image also depends on the performance of an image processing device which captures a document or the like on which the second electronic document is printed. Therefore, for example, if the variation of feature quantities of blocks of an image captured by an image processing device is significantly differs from the variation of feature quantities in embedded image data, the image is also determined to be unsuitable as a data addition target image.

For example, when the variation of chromaticity components is large, the variation of feature quantities of a captured image differs significantly from the variation of feature quantities in embedded image data. A feature quantity may be defined to be at least one of luminance components, chromaticity components, and the like. Such a chromaticity component is one or more color component in any color system such as the RGB color system. Steganographic information can be embedded using any feature quantity if a change in the feature quantity from an original image to a processed image is thought to be difficult to be found. A method for embedding data by steganography will be described in detail later.

In order to check whether or not the image is suitable to have steganographic information embedded therein, the still image acquired in step S5 is first divided into a plurality of blocks (step S6). The content conversion device 10 acquires a feature quantity for each block.

When the feature quantity for each block is acquired, the difference value acquisition possibility determining unit determines whether or not a difference value of feature quantities to be adjusted (e.g., B component in the RGB color system) can be calculated when two adjacent blocks are considered as a set of block pairs.

For example, the difference value acquisition possibility determining unit previously stores a map in which a color whose difference value cannot be acquired is defined for each image processing device which may be expected to capture the printed second electronic document or the like. Then, for example, in a case where an image processing device to perform capturing is a portable telephone having a camera, if tone values of all color components of the RGB color system is less than 50, it is determined that a difference value cannot be acquired. In each pixel, a map is represented as, for example, (R: gray-value is less than 50) and (G: gray-value is less than 50) and (B: gray-value is less than 50). However, any format of the map and any information contained in the map may be used.

The difference value acquisition possibility determining unit compares a stored map with an average of feature values of each block, and obtains the number of blocks from which a difference value can be acquired. Further, the difference value acquisition possibility determining unit stores, as a difference value acquisition threshold, the number of blocks from which a difference value required for embedding steganographic information can be acquired. The obtained number of blocks from which a difference value can be acquired is compared with the difference value acquisition threshold, and if the number of blocks from which a difference value can be acquired is greater than the difference value acquisition threshold, the still image is recognized as an image having a color in which steganography analysis can be performed by the image processing device (step S7). The difference value acquisition threshold may be stored as a ration of the number of blocks from which a difference value can be acquired to the number of blocks in the still image. When the acquired still image is an image having a color in which steganography analysis cannot be performed by the image processing device, the content conversion device 10 acquires a new still image (steps S7, S5).

When the acquired still image is an image having a color in which steganography analysis can be performed by the image processing device, the feature quantity variation determining unit determines whether or not the design of the still image complicates analysis of the embedded steganographic information (step S8). The feature quantity variation determining unit already stores a feature quantity difference threshold and a feature quantity variation threshold. The feature quantity difference threshold is a threshold for determining whether or not adjustment of a feature quantity is allowed with respect to two adjacent blocks (block pairs). If the variation of feature quantities between blocks is greater than a feature quantity difference threshold, it is highly likely that picture quality is greatly degraded, and therefore the feature quantities cannot be adjusted. The feature quantity variation threshold is the number of a block pair in which a feature quantity required for embedding steganographic information in a still image can be adjusted.

The feature quantity variation determining unit obtains a difference of an average of feature quantities between blocks for each block pair, and, if the variation of the feature quantities in a block pair is greater than the feature quantity difference threshold, the feature quantity variation determining unit determines that the block pair is unsuitable to have steganographic information embedded therein. The feature quantity variation determining unit obtains the number of block pairs whose feature quantities are unsuitable to be adjusted, and compares the number to the feature quantity variation threshold (step S8). If the number of block pairs whose feature quantities are unsuitable for adjustment is greater than the feature quantity variation threshold, the still image is unsuitable to have steganographic information embedded therein, and therefore the content conversion device 10 acquires another still image as an image to have steganographic information embedded therein (step S5). On the other hand, If the number of block pair whose feature quantities are unsuitable for adjustment is less than the feature quantity variation threshold, it is determined that the still image is suitable to have steganographic information embedded therein (step S8).

If the size of an image is too small even though the image is suitable to have steganographic information embedded therein, feature quantities may not be accurately recognized by the image processing device when the printed embedded image data or the like is captured by the image processing device. On the other hand, if the size of the still image is too large, blocks in which steganographic information is embedded may become so noticeable that the picture quality is degraded. Thus, when acquiring an image suitable to have steganographic information embedded therein, the embedded image generating unit 12 checks whether or not the size of the image is within a specific range (step S9). A proper image size may be set for each image processing device using a certain criterion. Although the image size depends on the performance of an image processing device for capturing one block may be made to be smaller than or equal to, for example, 0.8 mm square. When a portable telephone having a camera is used, both horizontal and vertical sizes of embedded image data are preferably 2 cm to 5 cm or so. Whether the size of the image in which steganographic information is to be embedded is within a specific range or not is determined, and if the image size is not suitable, the image is scaled up or down such that the image is suitable to have steganographic information embedded therein (steps S9, S10).

When the still image having a suitable size and a suitable color tone for steganographic embedding is obtained, the embedded image generating unit 12 embeds link information, such as a URL at which the non-still picture data is stored, in the still image by steganography (step S11). Embedding by steganography will be described in detail later.

{Generation of Electronic Document to be Outputted}

When the embedded image data is created by the embedded image generating unit 12, the electronic document converting unit 13 creates the second electronic document. The electronic document converting unit 13 inserts the embedded image data in place of the non-still picture data in the layout position of the non-still picture data of the electronic document 20 (step S12).

For example, in the example of an electronic document with a format such as HTML or XML, in the first electronic document, link information of non-still picture data between tags or a data name of non-still picture data is changed to link information indicating a storage position of embedded image data or a data name of embedded image data respectively, to generate the second electronic document.

When the second electronic document is generated, the content conversion device 10 outputs the second electronic document (step S14).

On the other hand, if it has been determined that generation of the second electronic document is not required with respect to the electronic document 20, the original electronic document 20 itself is outputted (step S14).

The operation illustrated in FIG. 3 is only one example and may be modified in various manners. For example, step S7 and step S8 in FIG. 3 may be performed in reverse order. Further, image size changing in steps S9, S10 may be performed before selection of an image suitable to have steganographic information embedded therein in steps S7 and S8.

### <Method for Embedding Data by Steganography>

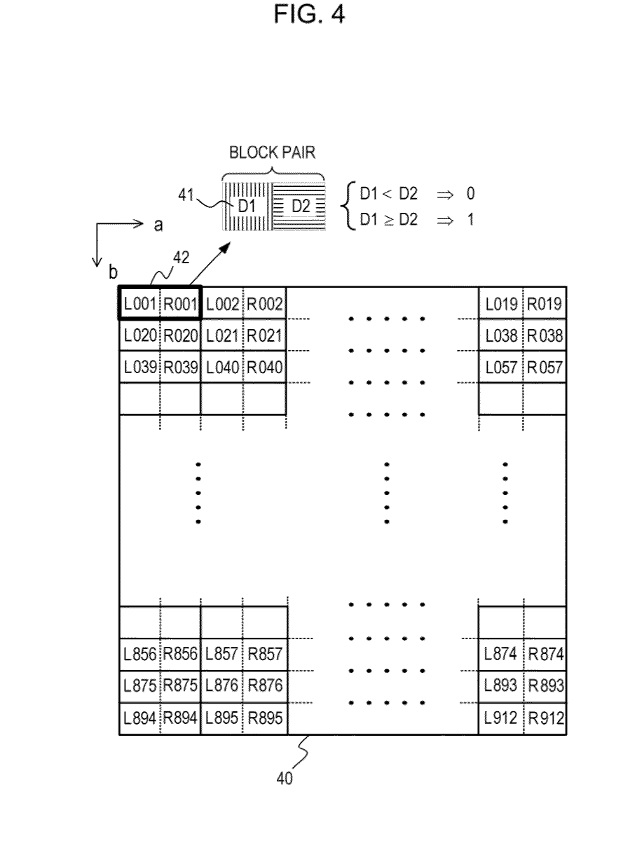

FIG. 4 is a diagram for explaining a method for embedding information in a data addition target image 40. The method for embedding data by steganography will be described in detail with reference to FIG. 4.

As illustrated in FIG. 4, the data addition target image 40 is divided into a plurality of blocks 41 of a suitable size. In the example of the figure, the image is divided into blocks having 38 blocks in a direction of arrow a and 48 blocks in a direction of arrow b. However, any number of blocks and any block size may be used. As used herein, the direction of arrow a is the horizontal direction and the direction of arrow b is the vertical direction in the description.

The data addition target image 40 is divided in 38 blocks 41 in the horizontal direction, and a block pair 42 has two blocks 41 that are adjacent in the horizontal direction. A top left block pair 42 has two blocks L001 and R001, and a block pair 42 to the right of the top left pair has two blocks L002 and R002. As a symbol given to each block, L denotes the left block 41 in a block pair 42, and R denotes the right block 41 in a block pair 42. A number part such as “001” and “002” in each block is a serial number of a block pair 42 with starting from the top left of the data addition target image 40. In the example illustrated in FIG. 4, there are 912 pairs of blocks 42 from a block pair 42 having L001 and R001 to a block pair 42 having L912 and R912. In the following description, for example, a block pair 42 having L001 and R001 is represented as (L001, R001).

{Method for Recording Information Using a Block Pair}

Each block pair 42 may indicate 1-bit of information according to the magnitude relation of feature quantities to be processed of left and right blocks 41. An example where the B component of the chromaticity components among feature quantities is adjusted will be described. In one block pair 42, it is assumed that an average density of B component is D1 in the left block 41 and an average density of B component is D2 in the right block 41. Average densities of blocks of the block pair 42 each corresponds to 0, 1, for example, as follows:

D1<D2: 0

D1>D2: 1

The embedded image generating unit 12 embeds link information represented as binary data in pairs of blocks 42 in a manner that embeds one digit in each block pair 42. For example, when embedding the first digit of the link information in a block pair 42 (L001, R001), the embedded image generating unit 12 reads each block 41 and calculates an average of feature quantities to be adjusted with respect to each block 41. When data “0” is to be embedded in the block pair 42 of (L001, R001), in (L001, R001) before processing, if L001 is denser than R001 in B component and the density relation indicates “1”, the embedded image generating unit 12 changes the densities of the B component in the two blocks 41 of L001 and R001 to adjust the average densities so that R001 is denser than L001 in the B component.

On the other hand, when “1” is to be embedded in the block pair 42 of (L002, R002), in (L002, R002) before processing, if L002 is denser than R002 in B component the density relation indicates “1”, the embedded image generating unit 12 does not perform adjustment of the B component, so that “1” is kept.

The embedded image generating unit 12 uses an information code counter to hold a bit number of the link information to be embedded. For example, when a binary number “101100” is stored, it is stored in order of “1”, “0”, “1”, “1”, “0”, “0” from the most significant bit. In this case, the information code counter sequentially assigns “1”, “2”, “3”, “4”, “5”, “6” to each of the bits.

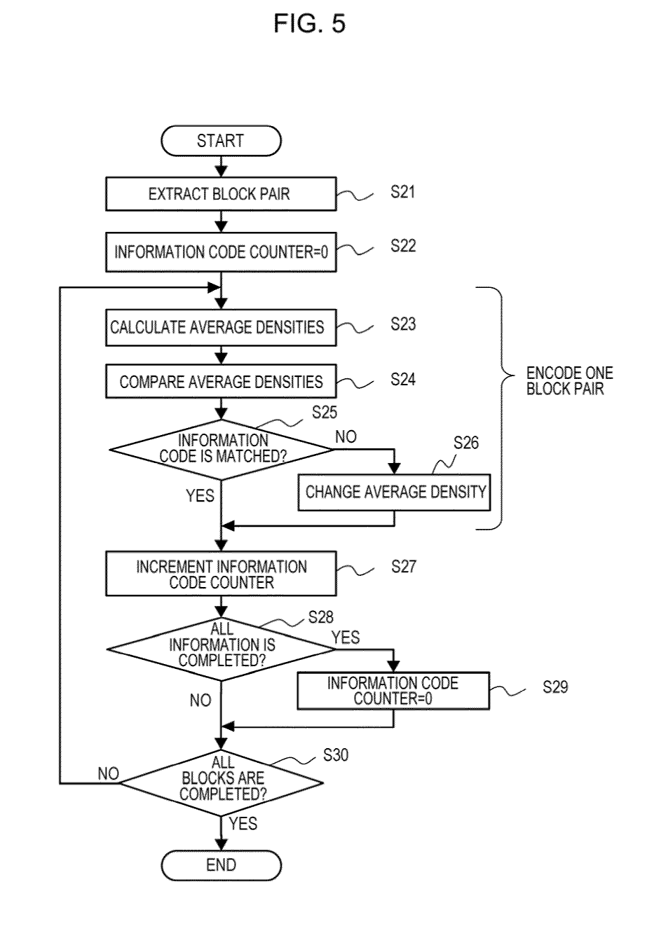

Next, an operation performed when information is embedded in the data addition target image 40 will be described with reference to FIG. 5. All the steps S21 to S30 are performed by the embedded image generating unit 12.

The embedded image generating unit 12 extracts a block pair 42 from the data addition target image 40 and sets the information code counter to “0” (steps S21, S22). With respect to the left and right blocks 41 of the extracted block pair 42, an average density of B component for example, which is a feature quantity to be adjusted, is calculated (step S23). The average densities are compared to recognize whether the block pair 42 being processed indicates “0” or “1”, and to check whether or not the indicated data matches the information code to be recorded (steps S24, S25). If the data indicated by the block pair 42 does not match the information code, the average densities of the B component of the blocks 41 in the block pair 42 are adjusted so that the block pair 42 represents the information code to be recorded (step S26).

When the block pair 42 is turned into the state to indicate the information code to be recorded, the embedded image generating unit 12 increments the information code counter by 1, and then checks whether or not all the bits of the link information have been recorded (steps S27, S28). Whether or not the binary data representing the link information has been recorded to the end is determined using the information code counter. The embedded image generating unit 12 previously stores the number of bits of link information to be recorded as “M” (where “M” is a natural number). If a value of the information code counter is less than M, it is determined that not all the link information has been recorded. On the other hand, if the value of the information code counter is greater than or equal to M, the embedded image generating unit 12 determines all the bits of the link information have been recorded, and resets the information code counter to 0 (step S29). When the value of the information code counter becomes greater than or equal to the number of bits of link information, the information code counter is reset to 0 so that link information desired to be recorded can be recorded repeatedly.

Then, the embedded image generating unit 12 determines whether the processing of steps S23 to S28 has been completed or not with respect to all the blocks of the data addition target image 40, and if the processing with respect to all the blocks has not been completed, the processing of steps S23 to S28 is repeated (step S30 NO). On the other hand, if no blocks 41 remain to which the processing of steps S23 to S28 may be applied, the embedding process is finished (step S30 YES).

As described above, embedded image data can be created by repeatedly recording link information using steganographic processing. While the second electronic document using embedded image data holds link information, the appearance of the second electronic document is not degraded compared to a case where URL or the like is displayed as characters.

<Hardware Configuration>

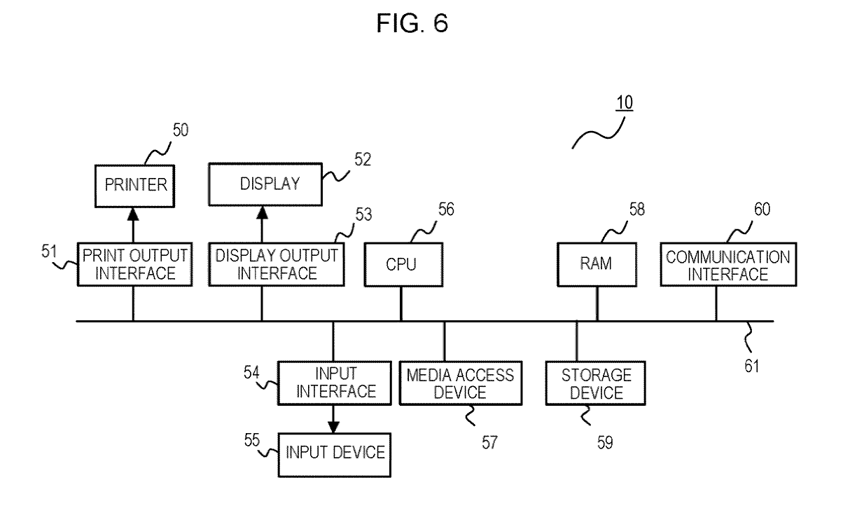

FIG. 6 is a diagram for explaining an example of a hardware configuration for performing content conversion. The content conversion device 10 is connected with a printer 50, a display 52, and an input device 55. In addition, the content conversion device 10 has a CPU 56, a media access device 57, a RAM 58, a storage device 59, and a communication interface 60.

The CPU 56 executes operation of peripheral equipment and various software, as well as a program which implements the content conversion method described in the present embodiment. The media access device 57 reproduces non-still picture data such as a moving picture. The RAM 58 is a volatile memory used for program execution. The storage device 59 stores a program and data required for the operation of the content conversion device 10, as well as a program which implements the content conversion according to the present embodiment. The communication interface 60 serves as an interface through which the content conversion device 10 is connected to a network.

These devices are configured to be connected to a bus 61 such that they can exchange data with one another. In addition, these devices can exchange data with the printer 50, the display 52, and the input device 55 using the bus 61.

The printer 50 sends/receives data to/from the content conversion device 10 through a print output interface 51. The display 52 sends/receives data to/from the content conversion device 10 through a display output interface 53, and the input device 55 sends/receives data to/from the content conversion device 10 through an input interface 54.

All of the above described devices may not be needed. Some of the above described devices may be omitted, or a plurality of displays 52 or the like may be provided, depending on design.

### Another Embodiment

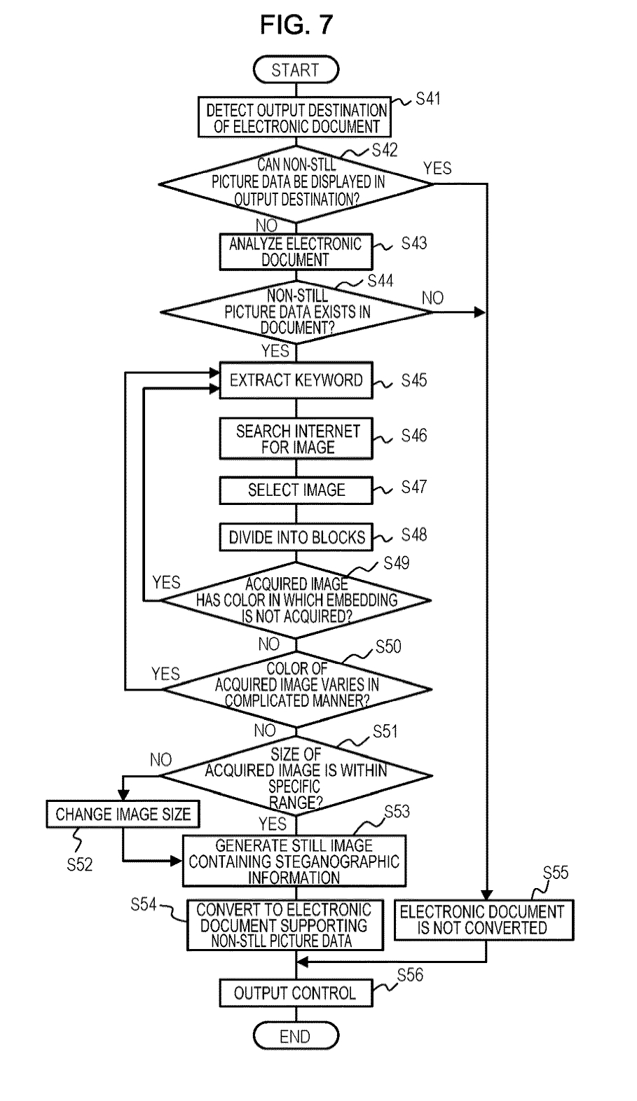

FIG. 7 is a flowchart of an operation of content conversion in another embodiment. Processing in a case where a frame cannot be extracted from non-still picture data, such as when the non-still picture data is sound data, will be described here. In such a case, an operation for acquiring a still image as a data addition target image is different from the operation in which non-still picture data is moving data. The other operations (steps S41 to S44 and steps S51 to S56) are the same as steps S1 to S4 and steps S9 to S14 of the above described embodiment.

If non-still picture data is data containing no frame such as sound data, the embedded image generating unit 12 searches the Internet to acquire a still image having an association with the non-still picture data. The content conversion device 10 may be configured to have a keyword extracting unit which extracts a keyword (for example, a file name of the non-still picture data) from information contained in the non-still picture data as needed. Searching on the Internet is performed using a keyword extracted by the keyword extracting unit. In the content conversion device 10 without the keyword extracting unit, the embedded image generating unit 12 may be configured to extract a keyword. In a further configuration, a keyword may be extracted from text data laid out near the non-still picture data in the electronic document 20 (step S45).

The content conversion device 10 searches the Internet for an image using the extracted keyword, and selects and acquires the image (step S46). After the acquired image is divided into a plurality of blocks, as in steps S7 and S8 of the above described embodiment, whether or not the image is suitable to have steganographic information embedded therein is determined (steps S48 to S50). If the image is a still image unsuitable to have steganographic information embedded therein, the acquisition of a still image is started again from the keyword search (step S45).

By the above described processing, even if non-still picture data is sound data, a still image having a strong association with the non-still picture data, such as an image of a CD jacket, can be obtained as a data addition target image, so that a user may easily predict the non-still picture data from the embedded image data. In addition, the user can access the non-still picture data without inputting a URL or the like as in the above described embodiment.

<Embodiment of an Image Processing Device for Processing Embedded Image Data>

Although the operation of the content conversion device 10 and the method for embedding link information has been described above, an image processing device which captures and processes embedded image data and an operation thereof will be described bellow. Information about non-still picture data contained in embedded image data is link information in the following description, but is not limited as such.

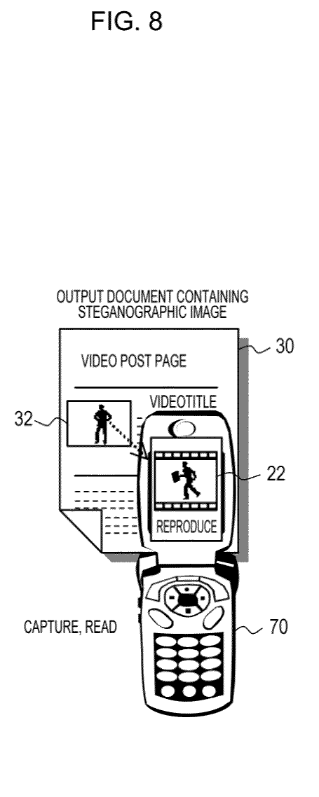

FIG. 8 is a diagram which illustrates an image processing device 70 accessing non-still picture data from embedded image data. The image processing device 70 for performing this operation may be any device or system, such as a portable telephone having a camera or a scanner connected to a computer, which can acquire an image, analyze link information, and access a URL where non-still picture data is stored. The image processing device 70 captures a printed document or the like to acquire a second electronic document as electronic data, and accesses non-still picture data using embedded image data contained in the second electronic document.

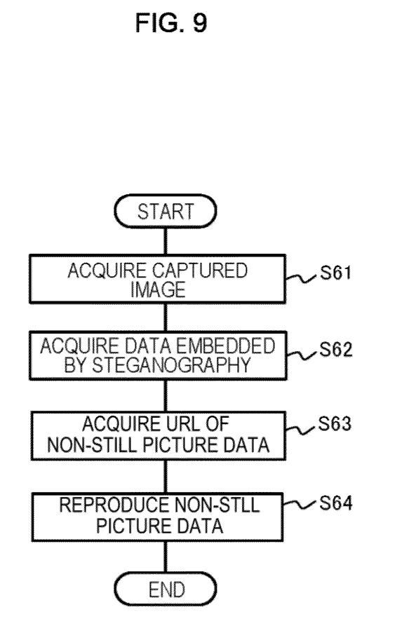

FIG. 9 is a flowchart of an operation performed by the image processing device when non-still picture data is displayed using embedded image data. As mentioned above, the image processing device 70 captures the printed document or the like to acquire the second electronic document as electronic data (step S61). Then, the image processing device recognizes embedded image data, and analyzes steganographic information embedded in the embedded image data to acquire link information (steps S62, S63). Upon acquiring the link information, the image processing device accesses the non-still picture data using the link information (step S64).

{Analysis of Link Information}

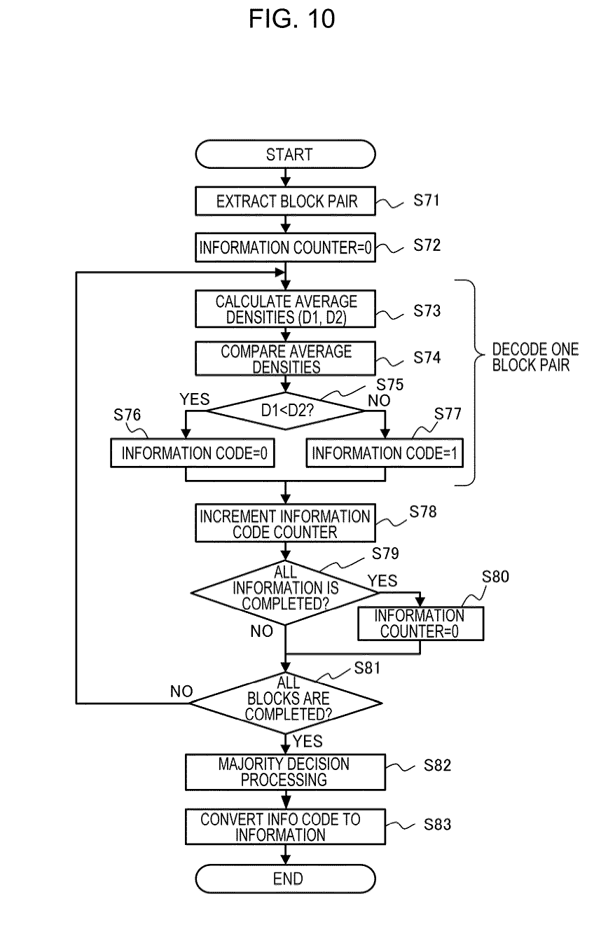

FIG. 10 is a flowchart of an operation performed by the image processing device when information about non-still picture data is acquired using embedded image data. After recognizing the embedded image data, the image processing device 70 divides the embeded image data into a plurality of blocks. Division performed here by the image processing device 70 is consistent with the block division performed by the content conversion device 10. To allow a block pair 42 to be detected, a condition of division is set in the image processing device 70 in advance. The condition required for this setting may be added to a part of the embedded image data, or may be in a definition file read by the image processing device 70. The image processing device 70 divides the embedded image data according to the set condition and extracts a block pair 42 (step S71). Then, the image processing device 70 resets the information code counter to 0 (step S72).

Then, the image processing device 70 calculates the averages of feature quantities (such as of a B component) of D1 and D2 adjusted with respect to the respective blocks of the block pair 42 acquired in step S71, and compares the averages (steps S73 to S75). If the average D1 of the left block 41 is less than the average of the right block 41, it is determined that “0” is recorded in the block pair 42, and information code “0” corresponding to the block pair is generated (steps S75, S76). On the other hand, if D1>D2, it is determined that “1” is recorded in the block pair 42, and information code “1” corresponding to the block pair is generated (steps S75, S77).

After analyzing the value recorded in the block pair 42, the image processing device 70 increments the information code counter by 1, and checks whether or not processing is completed with respect to all the information (steps S78, S79). Completion of processing with respect to all the information means here that all bits of recorded link information have been analyzed. Determination of whether whole link information has been analyzed or not is performed in a way similar to checking of whether whole link information has been recorded or not which is performed by the content conversion device 10 if steganography is applied. In other words, the image processing device 70 compares a value of the information code counter with a value M given as the number of digits of the link information, and if the value of the information code counter is greater then or equal to M, recognizes that the whole link information has been processed. When the whole link information has been processed, the information code counter is reset to 0 (step S80).

Then, the image processing device 70 determines whether or not the processing of steps S73 to S79 has been performed with respect to all the blocks in the image area. If the processing of steps S73 to S79 has not been completed with respect to all the blocks, the processing of steps S73 to S79 is performed with respect to an unprocessed block 41.

By the above described processing, the image processing device 70 can acquire the link information which is repeatedly embedded in the embedded image data. When the processing with respect to all the blocks is completed, the image processing device 70 has acquired the identical information as many times as it has been embedded in the embedded image data and therefore performs majority decision processing (step S82). Information obtained by the majority decision processing is used as the link information.

In the majority decision processing, an obtained information code is aligned as a number sequence having M digits and treated as M-digit information. In the following description, information code obtained from each block pair 42 is described as “c001” or the like, where “c” denotes information code. “001” is a serial number of a block pair 42 in which information code is stored, with reference to the left top of embedded image data. For example, assuming that the image processing device 70 has acquired 912 information codes and M is 19, the image processing device 70 has stored the same information 48 times. When they are aligned vertically as number sequences, information having the same information code counter value is aligned vertically as follows: “c001, c002, . . . , c019”, “c020, c021, . . . , c038”, “c039, c040, . . . , c057”, . . . , “c894, c895, . . . , c912”. Therefore, in information codes in a vertical sequence, numbers corresponding to the same digit of the link information (which is represented as a binary number) are recorded. Then, majority decision is performed in each sequence, so that a value as the majority of stored values is determined as data in a digit corresponding to an information code counter value. For example, c001, c020, c039, . . . , c894 are expected to store the same value. If, for example, c001, c039, . . . , c894 indicate “1” even though only c020 indicates “0”, the value recorded in the first digit is determined to be “1”. This processing is performed with respect to all of M digits to acquire the link information.

By the processing as described above, the image processing device 70 acquires link information embedded in embedded image data by steganography. Then, a user can access non-still picture data contained in an original electronic document using the acquired link information. Therefore, there is no need to manually input a URL, so that access to non-still picture data is made easier, and trouble due to an input error can be prevented.

<Hardware Configuration>

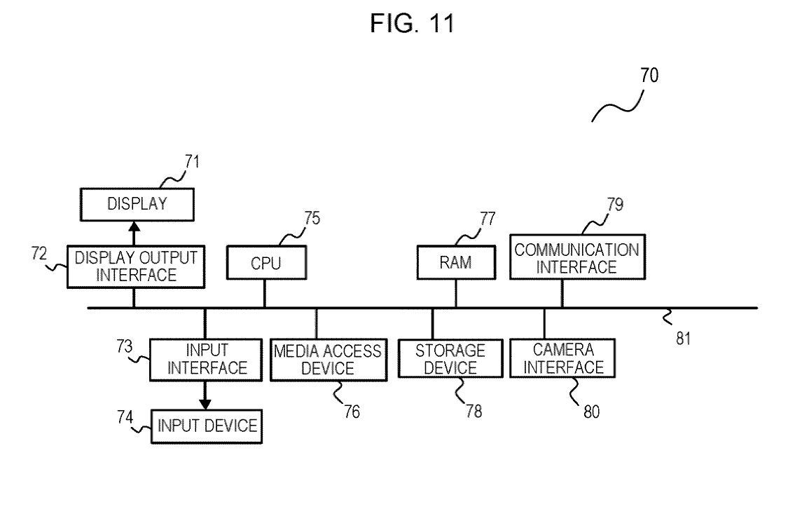

FIG. 11 is a diagram for explaining an example of a hardware configuration for reproducing non-still picture data. The image processing device 70 includes a CPU 75, a media access device 76, a RAM 77, a storage device 78, a communication interface 79, and a camera interface 80. In addition, the image processing device 70 has a display 71 and an input device 74. These devices exchange data with another device through a display output interface 72 and an input interface 73.

The CPU 75 executes various software as well as a program which implements the steganography analysis and link information acquisition described in the present embodiment. The media access device 76 reproduces non-still picture data accessed using link information. The RAM 77 is a volatile memory used for program execution. The storage device 78 stores a program and data required for operation of the image processing device 70 as well as a program which implements the steganography analysis and link information acquisition according to the present embodiment. The communication interface 79 serves as an interface through which the image processing device 70 is connected to a network. The camera interface 80 captures the second electronic document which contains embedded image data. The input device 74 is used for data input and the like by a user. The display 71 is used for displaying a screen during capturing of the printed second electronic document or the like, displaying non-still picture data, and so on. These devices are connected to a bus 81 so that they can exchange data one another.

Not all of the above described devices are needed. Some of the above described devices may be omitted, or a plurality of displays 71 or the like may be provided, depending on design.

### Other Examples

The present invention is not limited to above described embodiments and may be modified in various ways. Some examples will be described below.

For example, the foregoing system may be applied at a time when the electronic document 20 is outputted to a medium which can reproduce data such as a moving picture but cannot reproduce non-still picture data contained in the electronic document 20 to be displayed.

A URL has been described as a specific example of link information when the link information is recorded, however recorded information may not be a URL. If a value corresponding to a URL is determined in a one-to-one relation, and such a relation is stored in a database so as to be shared by the content conversion device 10 and the image processing device 70, the value from the database can be recorded as the link information.

Although the units such as the non-still picture data detecting unit 11 and the embedded image generating unit 12 provided in the content conversion device 10 are implemented as hardware circuitry composed of a plurality of parts, some or all of them can be implemented by software. Similarly, although the functions included in the image processing device 70 may be configured as hardware circuitry, some or all of them may be configured as software.

Although in the foregoing description, the B component of chromaticity components represented in the RGB color system is a feature quantity to be adjusted, the feature quantity to be changed may be any chromaticity component represented in any color system. Further, in addition to a chromaticity component, a luminance component may be used as a feature quantity to be varied, depending on a used contrast.

Although in the above description of the method for embedding steganographic information, a block pair 42 is formed in a horizontal direction, a block pair 42 is not necessarily formed in a horizontal direction. Since it is only necessary that a difference of feature quantities between two adjacent blocks can be obtained, a block pair 42 may be formed in a vertical direction so that data can be embedded therein. In this case, the image processing device 70 is preferably to be configured to analyze link information while recognizing a block pair 42 formed in a vertical direction.

As described above, the content conversion device 10 according to an embodiment generates, from a first electronic document containing non-still picture data, a second electronic document in which information having an association with the non-still picture data (for example, a URL) is embedded in place of the non-still picture data.

As a result, the second electronic document which can be outputted to a device that does not support non-still picture data can be generated without losing information about the first electronic document.

In addition, the image processing device 70 according to the embodiment acquires the non-still picture data contained in the first electronic document from the second electronic document that is displayed on a display device or printed.

As a result, a user can easily access the non-still picture data contained in the first electronic document using a printed document or the like created by the content conversion device 10 according to the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A content conversion device comprising:
a non-still picture data detecting unit which detects non-still picture data contained in a first electronic document that is an object to be processed;
an embedded image generating unit which generates, in a data addition target image representing a frame contained in the non-still picture data or an image associated with the non-still picture data, embedded image data in which information about the non-still picture data is embedded; and
an electronic document converting unit which creates a second electronic document in which the non-still picture data of the first electronic document is replaced with the embedded image data.

2. The content conversion device according to claim 1, further comprising a non-still picture data output control unit which determines whether or not the non-still picture data contained in the electronic document can be electronically displayed in an output destination of the electronic document,
wherein if the non-still picture data cannot be electronically displayed in the output destination of the electronic document, the non-still picture data output control unit requests the embedded image generating unit to generate the embedded image data.

3. The content conversion device according to claim 1,
wherein the embedded image generating unit comprises a still image selecting unit which selects the data addition target image,
wherein if a frame can be acquired from the non-still picture data, the embedded image generating unit selects at least one frame contained in the non-still picture data as the data addition target image, and
wherein if a frame cannot be acquired from the non-still picture data, the still image selecting unit searches the Internet to acquire at least one image associated with the non-still picture data, and selects the acquired image as the data addition target image.

4. The content conversion device according to claim 3, further comprising a keyword extracting unit which extracts a keyword used for retrieving data associated with the non-still picture data from the non-still picture data,
wherein the still image selecting unit searches the Internet for an image associated with the non-still picture data using the extracted keyword.

5. The content conversion device according to claim 1, wherein the embedded image generating unit generates the embedded image data by dividing the data addition target image into a plurality of blocks, associating a feature quantity for each of the blocks with the information about the non-still picture data, and adjusting the feature quantity.

6. The content conversion device according to claim 5, further comprising a difference value acquisition possibility determining unit which detects a difference value calculation enabled block in which a difference value between the feature quantities of a first block among a plurality of blocks and a second block adjacent to the first block can be calculated, and determines whether or not the data addition target image is a difference value calculation enabled image representing an image in which a total number of the difference value calculation enabled block is greater than a difference value acquisition threshold,
wherein if a first still image selected as the data addition target image is not the difference value acquisition enabled image, the embedded image generating unit selects a second still image from a frame contained in the still image data or an image associated with the still image data; and when the second still image is the difference value acquisition enabled image, the embedded image generating unit embeds the information about the non-still picture data in the second still image.

7. The content conversion device according to claim 5, further comprising a feature quantity variation determining unit which detects a feature quantity variation block pair in which a difference value between the feature quantities of a first block among a plurality of blocks and a second block adjacent to the first block is greater than a feature quantity variation threshold, and determines whether or not the data addition target image is a feature quantity variation image representing an image in which a total number of the feature quantity variation block pair is greater than the feature quantity variation threshold,
wherein if a second still image is not the feature quantity variation image, the embedded image generating unit embeds the information about the non-still picture data in the second still image, second still image being selected from a frame contained in the still image data or an image associated with the still image data if a first still image selected as the data addition target image is the feature quantity variation image.

8. The content conversion device according to claim 5, wherein if a block size of the plurality of blocks into which the data addition target image is divided is not within a specific range, the embedded image generating unit changes a size of the data addition target image such that the block size is within the specific range.

9. A storage medium in which a content conversion program is stored, the program causing a computer to execute processing, the processing comprising:
detecting non-still picture data contained in a first electronic document that is an object to be processed;
generating, in a data addition target image representing a frame contained in the non-still picture data or an image associated with the non-still picture data, embedded image data in which information about the non-still picture data is embedded; and
creating a second electronic document in which the non-still picture data of the electronic document is replaced with the embedded image data.

10. A content conversion method comprising:
detecting non-still picture data contained in a first electronic document that is an object to be processed;
generating, in the data addition target image representing a frame contained in the non-still picture data or an image associated with the non-still picture data, embedded image data in which information about the non-still picture data is embedded; and
creating a second electronic document in which the non-still picture data of the electronic document is replaced with the embedded image data.

11. An image processing device comprising:
an embedded data analysis unit which analyzes information about the embedded access target non-still picture data if, in a still image contained in data optically read from a printed document or an electronically displayed document, non-still picture data containing the still image as a frame or information about the access target non-still picture data which represents non-still picture data having an association with the still image is embedded; and
a non-still picture data reproducing unit which reproduces the access target non-still picture data using the information about the access target non-still picture data acquired by the embedded data analysis unit.

12. The image processing device according to claim 11, wherein the embedded data analysis unit acquires the information about the access target non-still picture data by dividing the still image contained in the optically read document into a plurality of blocks, and analyzing a result of comparison between feature quantities of a first block and a second block adjacent to the first block.

13. The image processing device according to claim 11, wherein the still image is generated by dividing a data addition target image representing a frame contained in the non-still picture data or an image associated with the non-still picture data, into a plurality of blocks, detecting a difference valued calculation enabled block in which a difference value between feature quantities of a first block among the plurality of blocks and a second block adjacent to the first block can be calculated, determining whether or not the data addition target image is a difference value acquisition enabled image representing an image in which a total number of the difference value calculation enabled block is greater than a difference value acquisition threshold, and generating embedded image data in which information about the non-still picture data is embedded if the data addition target image is the difference value acquisition enabled image.

14. The image processing device according to claim 11, wherein the still image is generated by dividing a data addition target image representing a frame contained in the non-still picture data or an image associated with the non-still picture data, into a plurality of blocks, detecting a feature quantity variation block pair in which a difference value between feature quantities of a first block among the plurality of blocks and a second block adjacent to the first block is greater than a feature quantity difference threshold, determining whether or not the data addition target image is a feature quantity variation image representing an image in which a total number of the feature quantity variation block pair is greater than a feature quantity variation threshold, and embedding the information about the access target non-still picture data in the still image if the data addition target image is not the feature quantity variation image.

15. A storage medium in which a content conversion program is stored, the program causing a computer to perform a process comprising:
dividing a still image into a plurality of blocks if, in the still image which is contained in a printed or an electronically displayed data, non-still picture data containing the still image as a frame or information about access target non-still picture data which represents non-still picture data having an association with the still image is embedded;
acquiring the embedded information about the access target non-still picture data by analyzing a result of comparison between feature quantities of a first block among the plurality of blocks and a second block adjacent to the first block; and
reproducing the access target non-still picture data using the information about the access target non-still picture data.
